(19) United States
(12) Patent Application Publication
(10) Pub. No.: US 2025/0011092 A1
(43) Pub. Date: Jan. 9, 2025

(54) GRIPPER LINK WITH A MOVABLE GRIPPER

(71) Applicant: RW Hartnett Co., Philadelphia, PA (US)

(72) Inventors: Frank James Anusky, Philadelphia, PA (US); Keith William Boyce, Southampton, PA (US)

(73) Assignee: RW Hartnett Co., Philadelphia, PA (US)

(21) Appl. No.: 18/347,665

(22) Filed: Jul. 6, 2023

(51) Int. Cl. B65G 17/40; B65G 17/32

(52) U.S. Cl. CPC B65G 17/40; B65G 17/326

(57) ABSTRACT

A conveyor gripper link that includes a movable gripper that adjust the gap in a product pocket defined between the body of the link and the gripper. In the initial or open stage, the product pocket gap is slightly larger than the product and the product may move. The gripper is selectively movable toward the product to close the product pocket gap and apply a stabilizing pressure to the product.

### TECHNICAL FIELD

The present disclosure relates to devices for product marking. The disclosed device is useful for controlling pharmaceutical products such as pills, capsules, and tablets during marking. More particularly, the present disclosure relates to the carrier links for holding and advancing the product through the marking machine.

### BACKGROUND

Pharmaceutical marking machines typically include a system for conveying pills, tablets, capsules, etc. between the introduction, marking, inspection, and discharge of a product. The marked product is then transported through an inspection device that inspects the indicia. The marked product is then advanced through a rejection device that disposes of any marked products that have failed inspection. Marked products that pass inspection are then discharged from the marking machine for final packaging or other processing.

Many of the known machines use a conveyor arrangement that imparts some vibration to the product and can cause the product to spin as it is carried through the machine. In some instances, the product has been observed rotating up to 45 degrees or more resulting in increased marking and/or inspection errors, and ultimately an increased rejection rate of the product.

### SUMMARY

The present disclosure addresses the prior art deficiency by providing a gripper link that includes a gripper that adjusts the gap between the product pocket defined between the body of the link and the gripper. In the initial or open stage, the product pocket gap is slightly larger than the product and the product may move. The gripper in the gripper link is movable toward the product to selectively close the product pocket gap and apply a stabilizing pressure to the product. The gripper link can reduce rotation of the product to 5 degrees or less, for example.

According to one aspect of the present disclosure, a system for marking individual consumable articles comprises a marking device, and conveyor for advancing individual articles through the marking device. The conveyor includes a plurality of links, wherein at least one link includes a pocket defined between a body of the link and a movable grip arm supported by the body. The grip arm is movable towards and away from the body to selectively apply a clamping force to a consumable article received in the pocket. The grip arm of the at least one link includes a first end having a surface at least partially defining the pocket and a second end opposite the first end, and the grip arm is pivotably secured to the body at a location between the first and second ends. The second end of the grip arm includes a first activation element, which causes the grip arm to pivot towards the body and apply a clamping force to a consumable article received in the pocket. The second magnetic component can be supported in a guide portion of the conveyor. The at least one link can include at least one roller, the guide portion can include at least one rail having a slot for receiving the at least one roller of the at least one link, and the second magnetic component is coextensive with at least a portion of the at least one slot along a direction of travel of the at least one link. The second magnetic component can be at least one of a strip magnetic component or a plurality of discrete magnetic components. The at least one link can include a biasing element for biasing the grip arm towards the first position. The system can further include an inspection device.

In accordance with another aspect, a link for conveying a product through a production process comprises a body configured for mounting on a product conveyor, and, a gripper that is movably supported by the body and cooperates with the body to define a product receiving gap between the gripper and the body. The product receiving gap between the gripper and the body is adjusted by moving the gripper towards the body.

The gripper can rotate on a shaft secured to the body. The gripper can have a first end that at least partially defining the product receiving gap and a second end, opposite the first end, that a first magnetic component. The gripper can include an abutment for opposing a biasing element. The abutment and the biasing element can be on opposite sides of the gripper. The biasing element can urge the gripper toward an open position.

In accordance with another aspect, a conveyor for transporting individual products comprises a plurality of gripper links, each gripper link has a movable gripper and a stationary member that define a product receiving gap, an endless conveyor on which the plurality of gripper links are mounted for transport; and a drive system for moving the endless conveyor. The endless conveyor includes a chain having a plurality of links, and each product receiving gap is magnetically adjusted by moving the movable gripper into and out of the product receiving gap.

### BRIEF DESCRIPTION OF THE DRAWINGS

The foregoing Summary and the following Detailed Description will be better understood when read in conjunction with the appended drawings, which illustrate an embodiment of the device. In the drawings:

FIG. 1 is a schematic of an exemplary marking machine;

FIG. 2 is a perspective view of an exemplary link with a product;

FIG. 3 is a perspective view showing the bottom of the gripper link in

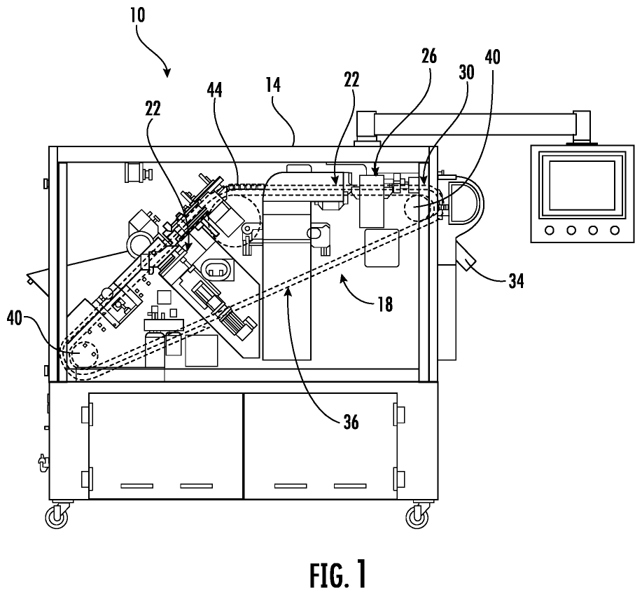

FIG. 1;

FIG. 4 is an exploded view of the gripper link in FIG. 1;

FIG. 5 is a side view of the gripper link in an open configuration;

FIG. 6 is a side view of the gripper link in a closed configuration;

FIG. 7 is a perspective view of a section of an exemplary assembly of s on a conveyor marking machine;

FIG. 8 is a cross-sectional view of the gripper link section along the line 8-8 in FIG. 7;

FIG. 9 is a sectional view illustrating an open gripper link; and,

FIG. 10 is a sectional view illustrating the closed configuration of a gripper link.

### DETAILED DESCRIPTION

The gripper link with be described in detail with reference to the drawings where the same of like elements are identified by the same reference numeral. The exemplary marking machine 10 illustrated in FIG. 1 has an enclosure 14 in which a conveyor system 18 is supported. The conveyor system 18 is typically configured to transport products entering at the left side of the machine 10, through a marking device 22, an inspection device 26, and a rejection device 30 to a discharge chute 34.

The conveyor system 18 generally includes a drive system, such as a chain or drive belt 36 that is supported for rotation about a plurality of sprockets 40. The chain 36 includes a plurality of product carrying links 44 that are moved along by the drive system and carry the product through the machine 10.

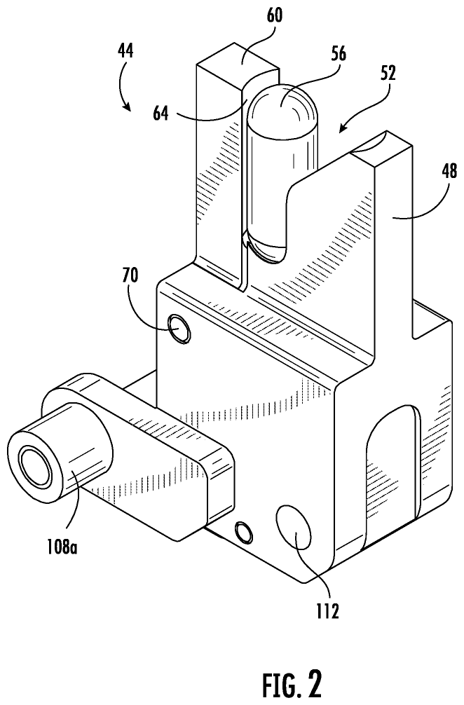

FIGS. 2 through 6 illustrate a gripper link 44 in accordance with the present disclosure. The gripper link 44 includes a body 48 with and interior surface 68 that is typically concave and forms one part of a pocket 52 for partially receiving a product to be conveyed. The gripper 60 has an interior surface 64, typically concave, that forms an opposing part of the product pocket 52 for partially receiving a product to be conveyed. In the illustrated embodiment, the product is a capsule 56 that is received in a vertical orientation in the pocket 52 between the interior surfaces 64 and 68. In the initial product receiving position, the gap between the interior surfaces 64 and 68 is greater than the diameter of the capsule 56. As explained herein with reference to FIGS. 5 and 6, this gap is closed to apply a securing pressure to capsule 56.

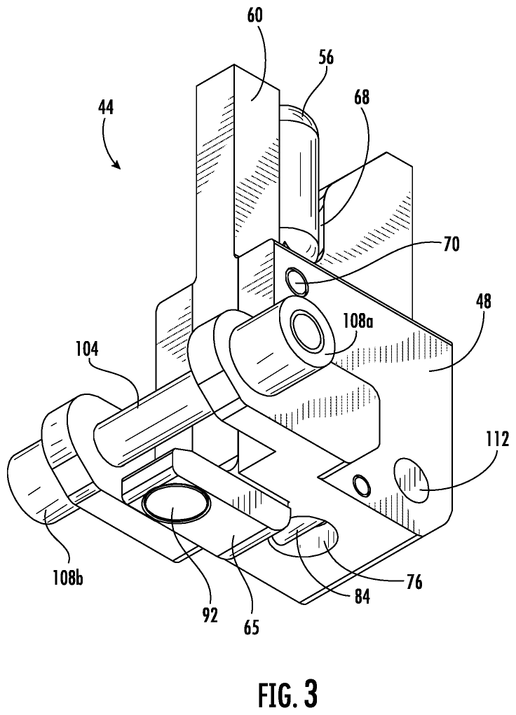

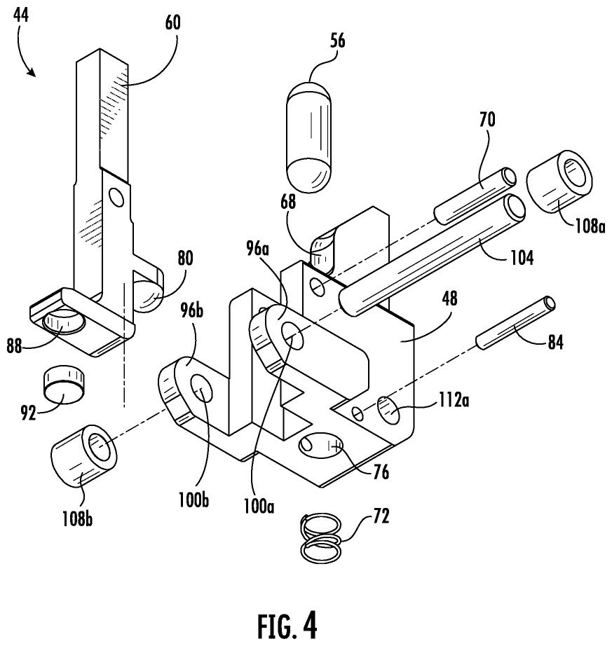

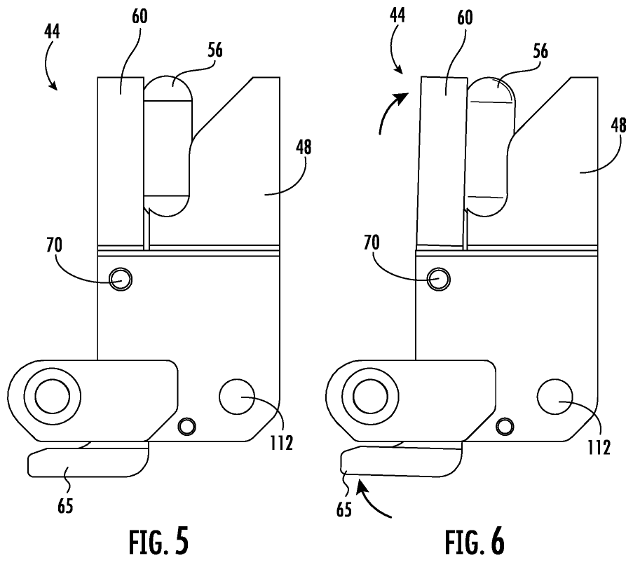

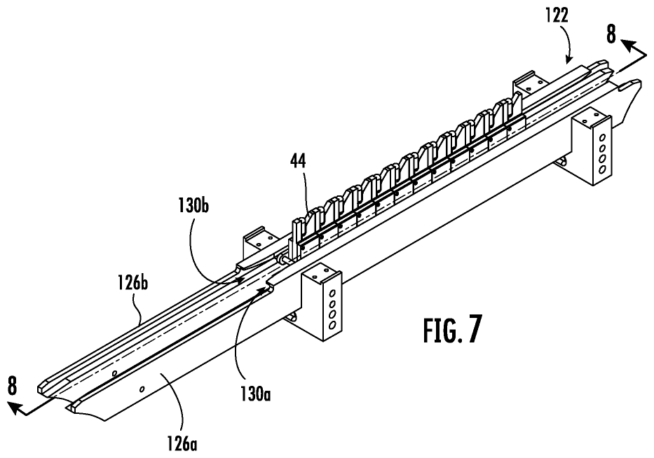

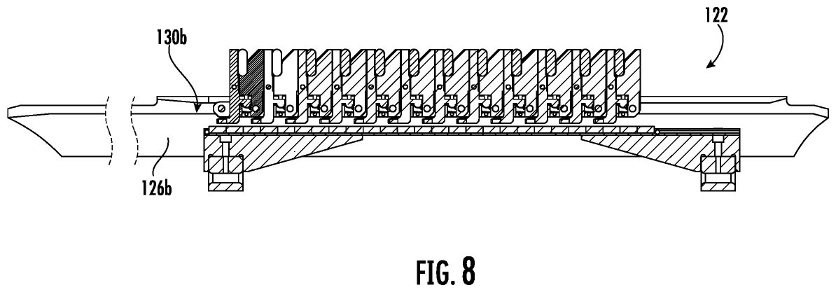

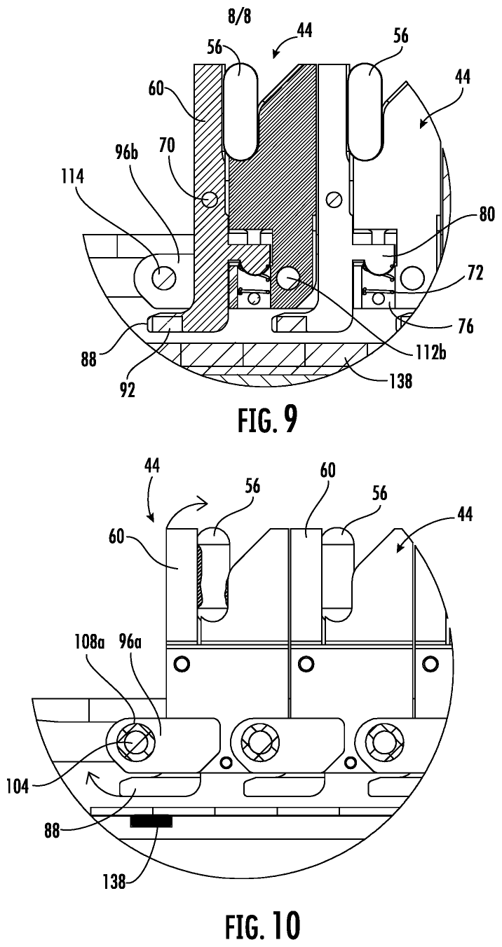

With reference to FIG. 3, the gripper 60 is pivotably supported on the body 48 by a pin or shaft 70 in the apertures 66 and 71 for movement to adjust the gap between a first position, such as open, and a second position, such as closed. In the first position, the capsule 56 is relatively loosely held in the product pocket 56 between the surfaces 64 and 68. In the second position, the gripper 60 closes the gap and applies pressure to the capsule 56. The pressure applied by the gripper can be adjusted according to the product and the product's resistance to deformation. The ability to stabilize the product, such as the capsule 56 during of transport through the system 10 may enable increased production speed and/or accuracy.

With reference to FIG. 4, the gripper 60 is biased towards the first position, open in this example, by a biasing element, such as spring 72. The spring 72 is received in a bore 76 at the base of the gripper link body 48 and acts against a projection 80 of the gripper 60. A spring retaining pin 84 in the bore 76 secures the spring 72. In this embodiment, with the spring 72 interposed between the spring retaining pin 84 and the projection 80, a force is applied to the gripper 60 such that it rotates about the shaft 70 and tends towards its first or open position.

Still with reference to FIG. 4, the gripper 60 has a general L-shape arm 61 comprised of a vertical portion 63 having a first end including the concave surface 64 and a second end with a foot-like portion 65 that extends away from the gripper link body 48. A bore 88 supports a magnetic component 92. As detailed above, the magnetic component 92 acts against one or more magnetic components of the same polarity within the conveyor system 18 such that the gripper 60 is rotated from the open position shown in FIG. 5 to the closed gap position shown in FIG. 6 to apply pressure to the carried article 56. In the closed position, rotation of the article 56 is limited to less than 15 degrees.

With reference to FIGS. 3, 4, 7 and 8, the illustrated plurality of gripper links 44 are mounted on rails 126 (a) and 126 (b) by an axle 104. The axle 104 extends through flanges 96 (a) and 96 (b) of the gripper link body 48 having bores 100 (a) and 100 (b). Rollers 108 (a) and 108 (b) are mounted on the axle 104 to guide the plurality of gripper links 44 as they move along the conveyor. The body 48 of each link 44 also includes bores 112a and 112b. It should be appreciated that adjacent links 44 are pivotally joined together with the axle 104 of a first link extending through the bores 112a and 112b of a second link.

Further with reference to FIGS. 7 and 8, an illustrative fragment of conveyor system 18 with a guide portion 122 of the endless conveyor system is shown. The endless conveyor system 18 can include one or more guide portions 122 that cooperate with the rollers 108a and 108b of each link 44 to stabilize the links 44. The guide portion 122 includes a pair of spaced-apart rails 126 (a) and 126 (b) that receive the rollers 108 (a) and 108 (b).

FIGS. 9 and 10 illustrate the placement of one or more magnetic components 138 at a location below the magnetic component 92. As stated previously, magnetic component 138 is of the same polarity as the magnetic component 92. As the magnetic fields of magnetic component 138 and the magnetic components 92 come into proximity, the magnetic fields oppose each other and the gripper 60 is rotated against the gripper link body 48.

The magnitude of the applied pressure can be controlled in various manners, such as altering the strength of the activation elements or the distance between them. Likewise, the shape and size of the gap between the interior surfaces 64 and 68 can be varied according to the product being transported, and/or the dimensions of the grip arm can all be configured to provide a wide range of clamping forces.

The activation elements can be electromagnetic components, or combinations thereof. Electromagnetic components can be more selectively energized to actuate one or more the plurality of gripper links 44 or to alter the applied force.

It will now be appreciated that aspects of the present disclosure increase efficiency by reducing or eliminating rotation of the product during at least marking and inspection operations, for example. Compared to conventional systems, which may exhibit product rotation of 45 degrees or more, the present gripper link reduces product rotation to less than 15 degrees and preferably to 5 degrees or less.

What is claimed is:

1. A system for marking consumable articles, the system comprising:
a marking device; and
a conveyor that includes a plurality of links for advancing articles through the marking device;
wherein at least one link includes an article pocket defined between a body portion of the at least one link and a movable grip arm of the at least one link; and
wherein the movable grip arm moves toward and away from the body portion to selectively apply a clamping force to an article within the pocket.

2. The system according to claim 1, wherein the movable grip arm includes a first end having a surface that at least partially defines the article pocket and a second end that is pivotably secured to the body portion at a location between the first and second ends.

3. The system according to claim 2, wherein the second end of the grip arm includes a first activation element and a second activation element is supported in proximity to the first activation element; whereby activation of the first and second activation elements cause the grip arm to pivot towards the body portion and apply a clamping force to an article in the article pocket.

4. The system according to claim 3, wherein the first and second activation elements are magnetic elements and the second magnetic component is supported in a guide portion of the conveyor.

5. The system according to claim 4, wherein the at least one link includes at least one roller, wherein the guide portion includes at least one rail having a slot for receiving the at least one roller of the at least one link, and wherein the second magnetic component is coextensive with at least a portion of the at least one slot along a direction of travel of the at least one link.

6. The system according to claim 5, wherein the second magnetic component is at least one of a strip magnetic component or a plurality of discrete magnetic components.

7. The system according to claim 1, wherein the at least one link includes a biasing element for biasing the grip arm towards the first position.

8. The system according to claim 1, further comprising an inspection device.

9. A link for conveying a product through a production process, the link comprising:
a body configured for mounting on a product conveyor; and,
a gripper that is movably supported on the body and cooperates with the body to define a product receiving gap between the gripper and the body;
wherein the product receiving gap between the gripper and the body is adjusted by moving the gripper towards the body.

10. The link according to claim 9, wherein the gripper rotates on a shaft secured to the body.

11. The link according to claim 10, wherein the gripper has a first end at least partially defining the product receiving gap and a second end, opposite the first end, that includes a first magnetic component.

12. The link according to claim 11, wherein the gripper includes an abutment for opposing a biasing element.

13. The link according to claim 12, wherein the abutment and the biasing element are on opposite sides of the gripper.

14. The link according to claim 13, wherein the biasing element urges the gripper toward an open position.

15. The link of claim 9, wherein the gripper has a first activation element that is selected to interact with a second activation element on a conveyor and cause movement of the gripper.

16. A conveyor for transporting individual products, the system comprising:
a plurality of links mounted on a conveyor, each link has a movable gripper and a stationary member that cooperate to define a product receiving gap;
a conveyor on which the plurality of gripper links are mounted for transport; and,
a drive system for moving the conveyor with the plurality of links; and,
an activation system for selectively moving the movable gripper into and away from the product receiving gap.
